(19) United States
(12) Patent Application Publication
(10) Pub. No.: US 2010/0058363 A1
(43) Pub. Date: Mar. 4, 2010

(54) Intent-Oriented User Interface Application Programming Interface

(75) Inventors: Nicolas J. Brun, Seattle, WA (US); Laurent Mouton, Bellevue, WA (US); Ryan J. Demopoulos, Bellevue, WA (US); Niraj D. Shah, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/200,067

(22) Filed: Aug. 28, 2008

(51) Int. Cl. G06F 9/44

(52) U.S. Cl. 719/328

(57) ABSTRACT

In accordance with one or more aspects of the intent-oriented user interface Application Programming Interface, a user interface platform includes an Application Programming Interface (API). An indication of multiple commands to be exposed for an application via a user interface is received from the application. For each of the multiple commands, a manner of display of a control corresponding to the command and a position for the control is determined on behalf of the application. Additionally, for each of the multiple commands the control corresponding to the command is displayed in accordance with the determined manner of display and the position for the control. The application is notified of user interactions with the user interface.

### BACKGROUND

Computer programs typically create a user interface with various control components that allow users to interact with the program. Such user interfaces are typically created by the program developer and can be displayed in any way they desire. Although this approach gives program developers great flexibility in defining user interfaces for their programs, it also has problems. One such problem is that a significant time investment on the part of the program developer is typically involved in order to create and manage the desired user interface.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects of the intent-oriented user interface Application Programming Interface, a user interface is presented for an application. The user interface is generated by a user interface platform based in part on an indication of commands to be exposed received from the application, but the presentation of controls of the user interface and an interaction model for the user interface is determined by the user interface platform. In response to user interaction with the user interface, the application is notified of the user interaction.

In accordance with one or more aspects of the intent-oriented user interface Application Programming Interface, an indication is received from an application, via an Application Programming Interface (API), of multiple commands to be exposed for the application via a user interface. For each of the multiple commands, a manner of display of a control corresponding to the command and a user interaction model for the control is determined on behalf of the application. For each of the multiple commands, the control corresponding to the command is displayed in accordance with the determined manner of display and the position for the control.

In accordance with one or more aspects of the intent-oriented user interface Application Programming Interface, an indication of multiple commands to be exposed via a user interface is sent to a user interface platform via an Application Programming Interface (API). The manner of interaction and position of controls in the user interface corresponding to the multiple commands is determined by the user interface platform, and a notification is received, via the API, of a user's intent with a user input to the user interface.

### BRIEF DESCRIPTION OF THE DRAWINGS

The same numbers are used throughout the drawings to reference like features.

FIG. 1 illustrates an example computing device implementing the intent-oriented user interface Application Programming Interface in accordance with one or more embodiments.

FIG. 2 is a flowchart illustrating an example process for implementing an intent-oriented user interface Application Programming Interface in accordance with one or more embodiments.

FIG. 3 illustrates an example process for initializing the intent-oriented user interface Application Programming Interface in accordance with one or more embodiments.

FIG. 4 illustrates an example system implementing the intent-oriented user interface Application Programming Interface in accordance with one or more embodiments.

FIG. 5 illustrates an example computing device that can be configured to implement the intent-oriented user interface Application Programming Interface in accordance with one or more embodiments.

### DETAILED DESCRIPTION

An intent-oriented user interface Application Programming Interface (API) is discussed herein. The API exposes functionality allowing an application to request that a user interface platform generate a user interface (UI) for the application, as well as allowing the application to identify commands for which controls are to be included in the user interface. The application identifies the particular commands for which controls are to be included in the user interface, but the user interface platform selects the positions and appearance in the user interface of the controls, and controls the user interaction model for the user interface.

The application also provides a command handler that the API can invoke when a particular command input is received from a user. Based on the user's interaction with the user interface, the API abstracts the particular user input that was received and informs the command handler of a user intent rather than a specific input. For example, the API can notify the command handler to execute a particular command rather than notifying the command handler of the particular action that was taken by the user to select the command (e.g., selection of a button, selection of a menu item, shaking a device, rotating a device with a gyroscope, etc.).

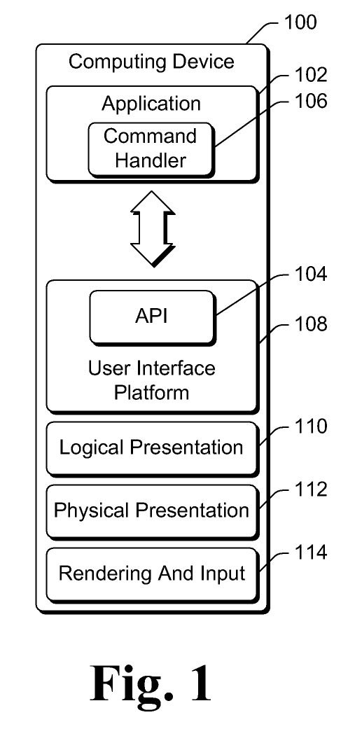

FIG. 1 illustrates an example computing device 100 implementing the intent-oriented user interface Application Programming Interface in accordance with one or more embodiments. Computing device 100 can be a variety of different devices capable of running applications. For example, computing device 100 can be a desktop computer, a server computer, a mobile station, an entertainment appliance, a set-top box communicatively coupled to a display device, a cell or other wireless phone, a game console, an automotive computer, a personal digital assistant, a digital or video camera, and so forth. Thus, computing device 100 can range from a full resource device with substantial memory and processor resources (e.g., personal computers, game consoles) to a low-resource device with limited memory and/or processing resources (e.g., traditional set-top boxes, hand-held game consoles).

Computing device 100 includes an application 102 having a command handler 106, an Application Programming Interface (API) 104 included as part of a user interface platform (or framework) 108, logical presentation module 110, physical presentation module 112, and rendering and input module 114. During operation, application 102 interacts with user interface platform 108 via API 104 in order to display or otherwise present a user interface via computing device 100, and also to perform commands input by a user of computing device 100. Generally, application 102 notifies API 104 of particular commands that are to be made available to the user via the user interface. User interface platform 108 displays or otherwise presents controls allowing users to invoke those particular commands. In response to selection of a particular one of these controls by a user, API 104 notifies application 102 of the particular selection made by the user.

Application 102 notifies API 104 of particular commands that are to be made available to the user, but user interface platform 108 determines specifically how user interface controls for those particular commands are presented to the user. These controls refer to the manner in which the user interface allows the user to input commands. These controls can take a variety of different forms, such as graphical user interface controls (e.g., icons, menu items, radio buttons, etc.), audible user interface controls (e.g., audio prompts), physical feedback controls (e.g., shaking a device, rotating a device with a gyroscope, etc.), and so forth.

It should be noted that each control has a type which outlines a structure for tracking the state of the control's commands, and also the data on the control itself (e.g., the name, an icon that is displayed, a tooltip that is displayed, and so forth). However, these structures for the controls do not include positional information about the control. Accordingly, the control is abstracted from its organization in the user interface.

Application 102 can notify API 104 of the particular commands that are to be made available to the user in a variety of different manners. In one or more embodiments, application 102 passes to API 104 a markup language description of the commands that are to be made available to the user. This markup language description can be an eXtensible Markup Language (XML) description, or alternatively another markup language description. Alternatively, application 102 can notify API 104 of these commands in different manners, such as a description in a different language or format, by invoking one or more interfaces exposed by API 104, by storing a description of the commands in a particular location (e.g., an operating system registry), and so forth.

In one or more embodiments, application 102 can specify general user interface parameters although the specific manner in which controls for the commands are presented to the user is determined by API 104. The general user interface parameters can include, for example, a template for the user interface. The template identifies a view or general type of user interface to be presented, such as a ribbon, dialog box, control panel, menu, toolbar, voice input, and so forth. The general user interface parameters can also include, for example, a general location for a specific command. The general location can be a zone or general area in the user interface where the control for the command is to be displayed or otherwise presented. For example, the application may be able to specify a top or bottom portion of a display area, a left or right portion of a display area, and so forth. The general user interface parameters can also optionally include a requested size (e.g., height and width) for the user interface, although user interface platform 108 can use a different size.

Despite these general user interface parameters, application 102 does not have control over the specific manner in which controls for the commands are displayed or otherwise presented. Rather, user interface platform 108 controls the specific manner in which controls for the commands are displayed or otherwise presented. The specific manner in which controls for the commands are displayed or otherwise presented includes, for example, the size of controls, the color of controls, specific images or icons displayed as part of the controls, whether and/or how disabled controls are displayed differently from enabled controls, and so forth. By way of example, application 102 may specify that a control for a “paste” command is to be displayed in the left-hand side of a ribbon. However, the size of that control, the color of that control, the specific position of the control in the left-hand side of the ribbon, and so forth are determined by user interface platform 108. Thus, application 102 need not be concerned with specific organization and display of the user interface, but rather can focus on the particular functionality that is to be made available via the user interface and leave the organization and display of the user interface to user interface platform 108.

User interface platform 108 can determine the specific manner in which controls are displayed or otherwise presented in a variety of different manners. In one or more embodiments, a set of rules or algorithms are used to determine a placement for the different controls. By way of example, the controls can be spaced evenly across a toolbar or ribbon, the controls can be given different sizes and/or shapes based on the desires of the API designer, and so forth. If the application indicated a particular template was to be used, then user interface platform 108 uses that template. Such templates can take a variety of different forms, such as different user interface types or views (e.g., ribbon, toolbar, menu, etc), different color schemes or languages, a particular arrangement for groups or collections of controls (e.g., group editing controls together, group reviewing/markup controls together, group printing/output controls together, etc.).

Once the user interface is displayed or otherwise presented by user interface platform 108, user interface platform 108 monitors user interaction with the user interface. This user interaction can take a variety of different forms. For example, particular commands can be input by the user selecting particular controls, such as the user activating a particular button, the user selecting a particular menu item, the user entering a particular voice command, the user shaking the device, and so forth. By way of another example, commands can be input by the user “hovering” over a particular control, such as by having his or her finger or stylus held over a particular control for a period of time, by having a cursor positioned over a particular control for a period of time, and so forth. The specific manner in which this detection is made is controlled by user interface platform 108. In other words, the user interaction model is controlled by user interface platform 108 rather than application 102. The user interaction model can include, for example, how the appearance of a control changes when selected by a user, how long a period of time a cursor, finger, or stylus need be held over a particular control, what constitutes shaking or rotating the device, and so forth.

Thus, not only does user interface platform 108 control the specific manner in which controls for the commands are displayed or otherwise presented, but user interface platform 108 also controls the user interaction model. The type outlining the structure for tracking the state of the control's commands discussed above can include data on the control itself, but the manner of interaction is controlled by platform 108. For example, application 102 can inform platform 108 of data to be displayed in a tooltip, but the determination of when to display the tooltip with that data is determined by platform 108.

User interface platform 108 can determine the specific values for the user interaction model in a variety of different manners. These can include, for example periods of time to wait before displaying a tooltip, when to stop displaying the tooltip, what constitutes shaking or rotating a device, and so forth. These specific values can be determined empirically, based on feedback from users and/or developers, based on the desires of the designer of user interface platform 108, and so forth.

A notification of user interaction that is detected by user interface platform 108 is communicated to a command handler 106 of application 102. This notification is an abstraction of the particular action that the user performed and informs command handler 106 of an intent of the user rather than a specific input made by the user. By way of example, when user interface platform 108 detects that the user has held a stylus over a particular control for a period of time then user interface platform 108 notifies command handler 106 that the user's intent is to “preview” the command corresponding to that particular control. User interface platform 108 need not inform command handler 106 of the specific manner in which the user requested the “preview”. By way of another example, when user interface platform 108 detects that the user has selected a particular menu item then user interface platform 108 notifies command handler 106 that the user's intent is to execute the command corresponding to that particular control. User interface platform 108 need not inform command handler 106 of the specific manner in which the user requested that the command be executed.

Command handler 106 receives these notifications from user interface platform 108 and responds accordingly. The specific manner in which command handler 106 and/or application 102 respond varies by application and by implementation. For example, the command handler 106 and/or application 102 can execute the user-entered command, display different information or take different actions for previewing the command, and so forth.

API 104 also receives communications from application 102 regarding the status of application 102 and/or commands for application 102. This information received from application 102 can be used by user interface platform 108 in determining how to display or otherwise present the user interface. For example, application 102 can notify API 104 that a particular command is currently disabled. In response, user interface platform 108 can display or otherwise present the control for that command in a different manner to reflect that the command is currently disabled. This different manner can take a variety of different forms, such as graying out the control, not displaying the control, displaying the control using a different color, and so forth. The specific manner in which the display or other presentation of the command is changed is controlled by user interface platform 108.

In one or more embodiments, in order to display or otherwise present the user interface, user interface platform 108 employs one or more of a logical presentation module 110, a physical presentation module 112, and a rendering and input module 114. API 104 invokes logical presentation module 110 to generate controls for the user interface. Logical presentation module 110 generates the logical presentation for a particular command. This logical presentation can be, for example, a Boolean command, a collection, and so forth. Logical presentation module 110 invokes physical presentation module 112 to display particular physical objects corresponding to the logical presentation. These physical objects can be, for example, rectangles or other geometric shapes, borders, text and/or graphics, and so forth. Physical presentation module 112 invokes rendering and input module 114 to draw or otherwise output in the various parts of the physical objects. These various parts can be, for example, lines, text, images, audible outputs, and so forth.

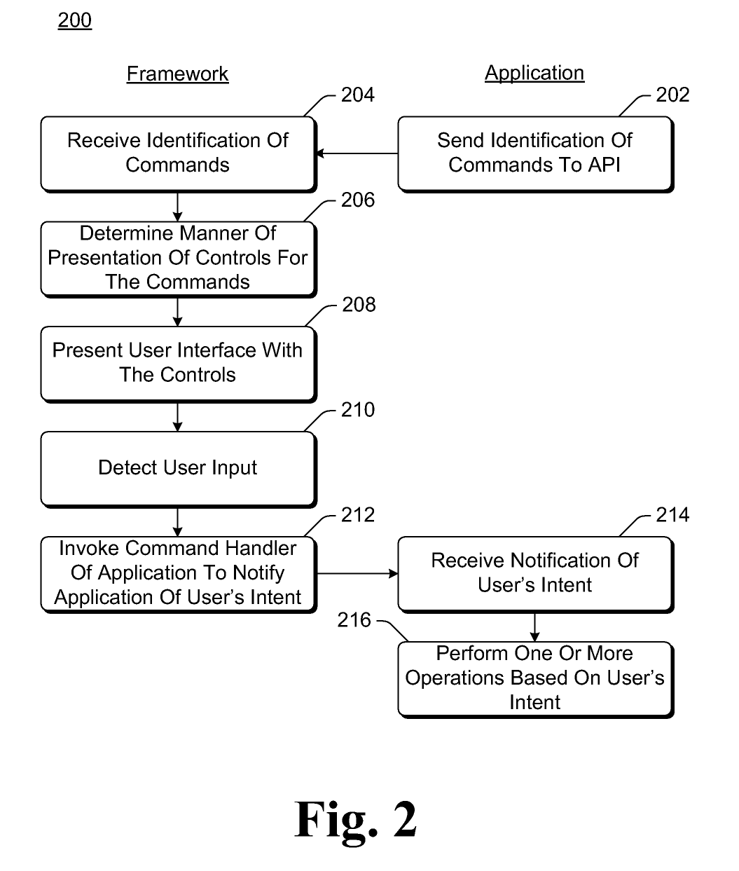

FIG. 2 is a flowchart illustrating an example process 200 for implementing an intent-oriented user interface Application Programming Interface in accordance with one or more embodiments. Process 200 can be implemented in software, firmware, hardware, or combinations thereof. Acts of process 200 illustrated on the left-hand side of FIG. 2 are carried out by a framework (or platform) and/or API, such as user interface platform 108 and/or API 104 of FIG. 1. Acts of process 200 illustrated on the right-hand side of FIG. 2 are carried out by a command handler and/or an application, such as command handler 106 and/or application 102 of FIG. 1. Process 200 is an example process for using the intent-oriented user interface Application Programming Interface; additional discussions of using the intent-oriented user interface Application Programming Interface are included herein with reference to different figures.

In process 200, the application sends to the framework an identification of commands that are to be presented via the user interface (act 202). This identification can take a variety of different forms, such as an XML description, or alternatively other forms as discussed above.

The framework receives the identification of the commands from the application (act 204), and determines on behalf of the application a manner of presentation of controls for the commands (act 206). This determination of presentation of the controls can be performed in a variety of different manners, as discussed above.

The user interface with the controls is displayed or otherwise presented by the framework (act 208). The manner in which the user can interact with the controls (the user interaction model) is determined by the framework, as discussed above. The presentation of controls, such as the positions of controls that are displayed, is also determined by the framework as discussed above. Additionally, the framework detects user inputs via the user interface (act 210), as discussed above. Once user input is detected, a command handler of the application is invoked to notify the application of the user's intent with the user input (act 212). As discussed above, this notification is an abstraction of the particular action that the user performed, and informs the command handler of an intent of the user rather than a specific input made by the user.

The application, via the command handler, receives this notification of the user's intent (act 214). The application responds by performing one or more operations based on the user's intent (act 216), as discussed above.

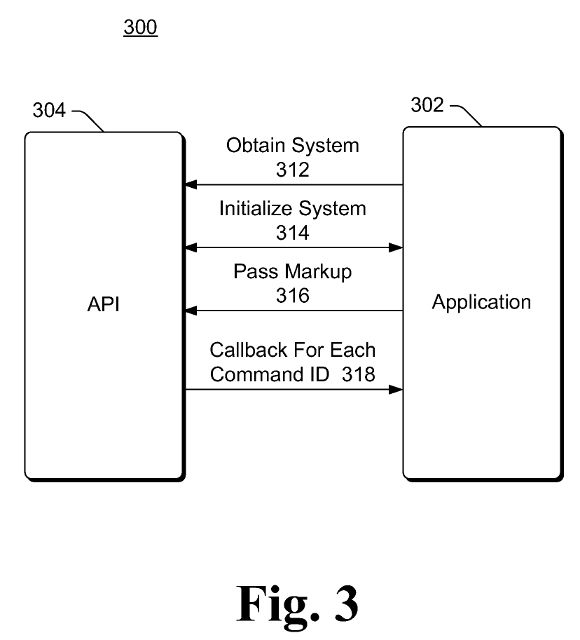

FIG. 3 illustrates an example process 300 for initializing the intent-oriented user interface Application Programming Interface in accordance with one or more embodiments. FIG. 3 illustrates an application 302 which can be, for example, an application 102 of FIG. 1. FIG. 3 also illustrates an API 304 which can be, for example, an API 104 of FIG. 1. Although multiple individual acts are illustrated in FIG. 3, it is to be appreciated that one or more of these acts can be combined, and/or one or more of these acts can be performed as multiple acts.

As part of the initialization process, the API system is obtained (act 312). Obtaining the API system refers to initiating, instantiating, or otherwise executing API 304. In one or more embodiments, act 312 is performed by application 302 making a CoCreateInstance call to instantiate API 304 for application 302.

After obtaining the API system, the API system is initialized (act 314). Initializing the API system refers to engaging API 304 so that API 304 and application 302 can communicate with one another. In one or more embodiments, as part of this initialization application 302 passes to API 304 a reference to itself, allowing API 304 to communicate back to application 302. Application 302 also implements an IUIApplication interface, allowing API 304 to make callbacks to application 302 to obtain information regarding control status and properties, to initiate commanding, and so forth. API 304 implements an IUIFramework interface via which application 302 can communicate with API 304.

Additionally, in one or more embodiments this initialization 314 includes API 304 and application 302 negotiating a size of the user interface. This negotiation can include a request on the part of application 302 for a particularly-sized user interface, and a response by API 304. API 304 can use a variety of different rules and/or criteria in deciding how large a portion of the display (or how much of some other presentation space) can be consumed by the user interface. One or more additional requests and/or responses can also be communicated between API 304 and application 302 as part of this size negotiation in act 314.

Application 302 then passes to API 304 a markup identifying the commands to be made available via the user interface (act 316). Alternatively, this identification can be passed in other manners rather than using a markup, as discussed above. In one or more embodiments, this markup is a binary (compiled) markup, although uncompiled descriptions can alternatively be used. Each command to be made available via the user interface has a command ID, allowing application 302 and API 304 to communicate regarding a particular command. Multiple controls presented as part of the user interface, however, can correspond to the same command and thus have the same command ID. For example, a “paste” command may have a control displayed via a toolbar button and a control displayed as a menu item, and both of these controls correspond to the same “paste” command.

API 304 then performs, for each command ID received in act 316, a callback to application 302 (act 318). This callback operates as a request for a command handler for each command ID. Application 302 returns, to API 304, an identifier of the command handler for the command ID. This allows API 304 to know which command handler of application 302 to invoke in response to user input of a particular command. In one or more embodiments, for each command ID specified in the markup in act 316, API 304 makes an OnCreateUICommand call to application 302.

It should be noted that a particular command is typically associated with a single command ID, although multiple controls displayed or otherwise presented via the user interface can correspond to that single command ID. For example, a user interface may present controls allowing the user to input a particular command by selecting an icon on a ribbon and also by selecting a menu item. Although these two different controls allow the user to input the particular command in two different ways, both of these two different controls correspond to the same command and thus the same command ID.

Upon the completion of process 300, the user interface is initialized and can be displayed to the user. Communication between API 304 and application 302 can continue, and command handlers of application 302 can be invoked as appropriate as discussed above.

Returning to FIG. 1, various interfaces are exposed by application 102 (e.g., as part of command handler 106) and API 104 to facilitate communication between application 102 and API 104. The following discussion includes example interfaces, enumerations, and properties that can be used by API 104 and/or application 102 in accordance with one or more embodiments. It is to be appreciated that these discussions include various examples, and that alternatively different interfaces, enumerations, properties, and/or other values can be used.

Portions of the following discussions make reference to an example implementation of a user interface that is a ribbon. A ribbon refers to a band that is displayed with multiple controls included therein. The ribbon is typically a horizontal or vertical band, but alternatively can be displayed in different directions. The ribbon can be expanded so that one or more controls are displayed, or collapsed so that only an indicator of the ribbon is displayed. Expanding and collapsing of the ribbon can be performed in response to user commands (e.g., selections of particular portions of the ribbon). It is to be appreciated that the ribbon is one example of a user interface, and that alternatively other user interfaces can be employed.

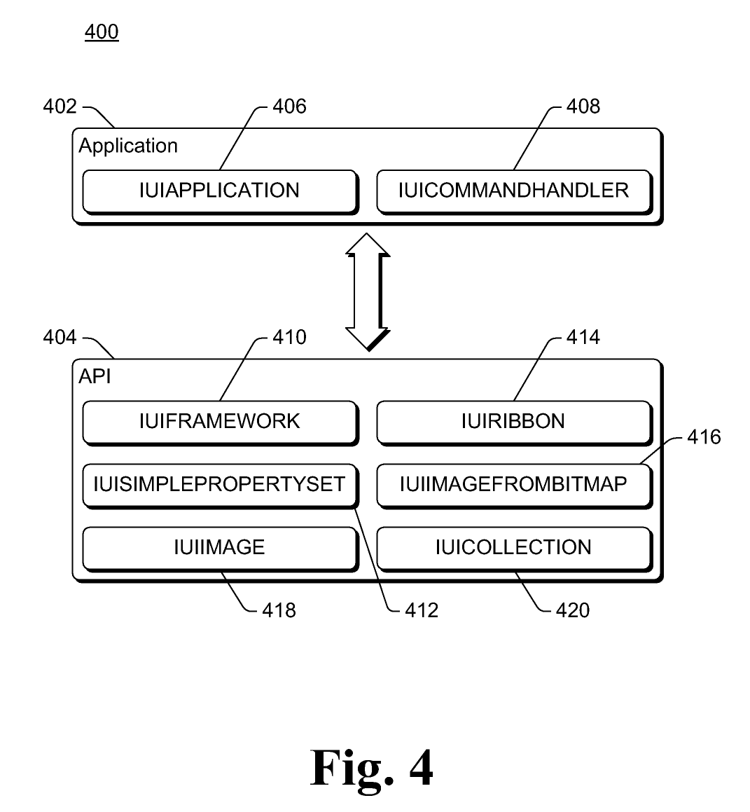

FIG. 4 illustrates an example system 400 implementing the intent-oriented user interface Application Programming Interface in accordance with one or more embodiments. System 400 includes an application 402 which can be, for example, application 102 of FIG. 1. System 400 also includes an API 404 which can be, for example, API 104 of FIG. 1.

A variety of different interfaces are included in system 400, allowing communication between application 402 and API 404. Application 402 includes an IUIAPPLICATION interface 406 and an IUICOMMANDHANDLER interface 408. API 404 includes an IUIFRAMEWORK interface 410, an IUISIMPLEPROPERTYSET interface 412, an IUIRIBBON interface 414, an IUIIMAGEFROMBITMAP interface 416, an IUIIMAGE interface 418, and an IUICOLLECTION interface 420. These example interfaces are discussed in more detail below.

A variety of different enumerations are used as part of this example API 104 and/or application 102. These enumerations include:
UI_COMMAND_INVALIDATIONFLAGS
UI_COMMAND_TYPE
UI_COMMAND_EXECUTIONVERB
UI_VIEW_VERB
UI_COMMAND_CONTEXTAVAILABILITY
UI_COMMAND_FONTPROPERTIES
UI_CONTROL_DOCK
   These example enumerations are discussed in more detail below with reference to Tables I-VII. In one or more embodiments, these enumerations are defined by logical presentation entity 110 of FIG. 1.

The UI_COMMAND_INVALIDATIONFLAGS enumeration includes flags to indicate to the framework the invalidation behavior desired by the application. Table I describes an example of the UI_COMMAND_INVALIDATIONFLAGS enumeration. It is to be appreciated that Table I describes only an example, and that other enumeration definitions can alternatively be used.

TABLE I
typedef [v1_enum] enum UI_COMMAND_INVALIDATIONFLAGS
{

| | | |
|---|---|---|
| UI_CIF_STATE | = 0x00000001, | // UI_PKEY_Enabled |
| UI_CIF_VALUE | = 0x00000002, | // Value property |
| UI_CIF_PROPERTY | = 0x00000004, | // Any property |
| UI_CIF_ALLPROPERTIES | = 0x00000008 | // All properties |

} UICOMMAND_INVALIDATE_FLAGS;

The UI_COMMAND_TYPE enumeration includes IDs that denote the type of commands in the framework. These command types describe the controls that are presented to allow a user to input a command. Table II describes an example of the UI_COMMAND_TYPE enumeration. It is to be appreciated that Table II describes only an example, and that other enumeration definitions can alternatively be used.

TABLE II

| typedef [v1_enum] enum UI_COMMAND_TYPE | |
|---|---|
| { | |
| UI_CT_UNKNOWN | = 0, |
| UI_CT_GROUP | = 1, |
| UI_CT_ACTION | = 2, |
| UI_CT_ANCHOR | = 3, |
| UI_CT_CONTEXT | = 4, |
| UI_CT_COLLECTION | = 5, |
| UI_CT_COMMAND_COLLECTION | = 6, |
| UI_CT_DECIMAL | = 7, |
| UI_CT_BOOLEAN | = 8, |
| UI_CT_FONT | = 9, |
| UI_CT_RECENTITEMS | = 10, |
| UI_CT_COLOR_ANCHOR | = 11, |
| UI_CT_COLOR_COLLECTION | = 12, |
| } UI_COMMAND_TYPE; | |

The UI_COMMAND_EXECUTIONVERB enumeration identifies a type of action that a user can take for a command. By way of example, when a user hovers over some visual control, this enumeration indicates that a preview of the command corresponding to the control is to be initiated. Table III describes an example of the UI_COMMAND_EXECUTIONVERB enumeration. It is to be appreciated that Table III describes only an example, and that other enumeration definitions can alternatively be used.

TABLE III

| typedef [v1_enum] enum UI_COMMAND_EXECUTIONVERB | |
|---|---|
| { | |
| UI_CEV_EXECUTE | = 0, |
| UI_CEV_PREVIEW | = 1, |
| UI_CEV_CANCELPREVIEW | = 2 |

} UI_COMMAND_EXECUTIONVERB;

The UI_VIEW_VERB enumeration identifies the nature of a change to a view. For example, such a change could be “a view has been destroyed”. Table IV describes an example of the UI_VIEW_VERB enumeration. It is to be appreciated that Table IV describes only an example, and that other enumeration definitions can alternatively be used.

TABLE IV

```
typedef [v1_enum] enum UI_VIEW_VERB
    {
        UI_VV_CREATE,
        UI_VV_DESTROY,
        UI_VV_SIZE,
        UI_VV_ERROR,
    } UI_VIEW_VERB;
```

The UI_COMMAND_CONTEXTAVAILABILITY enumeration is used in conjunction with the property PKEY_ContextAvailable, discussed in more detail below. Table V describes an example of the UI_COMMAND_CONTEXTAVAILABILITY enumeration. It is to be appreciated that Table V describes only an example, and that other enumeration definitions can alternatively be used.

TABLE V

| typedef [v1_enum] enum | |
|---|---|
| UI_COMMAND_CONTEXTAVAILABILITY | |
| { | |
| UI_CCA_NOTAVAILABLE | = 0, |
| UI_CCA_AVAILABLE | = 1, |
| UI_CCA_ACTIVE | = 2, |

} UI_COMMAND_CONTEXTAVAILABILITY;

The UI_COMMAND_FONTPROPERTIES enumeration is used in conjunction with various font command properties, discussed in more detail below. Table VI describes an example of the UI_COMMAND_FONTPROPERTIES enumeration. It is to be appreciated that Table VI describes only an example, and that other enumeration definitions can alternatively be used.

TABLE VI

| typedef [v1_enum] enum UI_COMMAND_FONTPROPERTIES | |
|---|---|
| { | |
| UI_CFP_NOTAVAILABLE | = 0, |
| UI_CFP_NOT_SET | = 1, |
| UI_CFP_SET | = 2, |

} UI_COMMAND_FONTPROPERTIES;

The UI_CONTROL_DOCK enumeration determines the position of a control in the user interface, such as the QAT (Quick Access Toolbar). The UI_CONTROL_DOCK is used in conjunction with PKEY_QuickAccessToolbarDock, discussed in more detail below. The Quick Access Toolbar is a customizable toolbar used with various user interfaces, such as user interfaces having multiple tabs with different commands associated with (and displayed for) each tab. The Quick Access Toolbar includes a set of commands that are displayed independently of the tab that is currently displayed and can be displayed, for example, as a row of commands above the displayed tabs. Table VII describes an example of the UI_CONTROL_DOCK enumeration. It is to be appreciated that Table VII describes only an example, and that other enumeration definitions can alternatively be used.

TABLE VII

```
typedef [v1_enum] enum UI_CONTROL_DOCK
{
    UI_CD_TOP  = 1,
    UI_CD_BOTTOM = 3,
} UI_CONTROL_DOCK;
```

Additionally, various properties are used by API 104 and user interface platform 108, and/or application 102. These various properties are used to define various aspects of the user interface being presented by user interface platform 108. Examples of these various properties are included in Tables VIII-XVI below. These examples also include example types for the properties.

Table VIII illustrates examples of core command properties. The core command properties refer to properties describing a particular command for which a control is to be presented as part of the user interface. It is to be appreciated that Table VIII describes only examples, and that other core command properties can alternatively be used.

TABLE VIII

| | | |
|---|---|---|
| cpp_quote(“DEFINE_UIPROPERTYKEY(UI_PKEY_Enabled, | VT_BOOL, | 1); ”) |
| cpp_quote(“DEFINE_UIPROPERTYKEY(UI_PKEY_LabelDescription, | VT_LPWSTR, | 2); ”) |
| cpp_quote(“DEFINE_UIPROPERTYKEY(UI_PKEY_Keytip, | VT_LPWSTR, | 3); ”) |
| cpp_quote(“DEFINE_UIPROPERTYKEY(UI_PKEY_Label, | VT_LPWSTR, | 4); ”) |
| cpp_quote(“DEFINE_UIPROPERTYKEY(UI_PKEY_TooltipDescription, | VT_LPWSTR, | 5); ”) |
| cpp_quote(“DEFINE_UIPROPERTYKEY(UI_PKEY_TooltipTitle, | VT_LPWSTR, | 6); ”) |
| cpp_quote(“DEFINE_UIPROPERTYKEY(UI_PKEY_LargeImageHighColor, | VT_UNKNOWN, | 7); ”) // IUIImage |
| cpp_quote(“DEFINE_UIPROPERTYKEY(UI_PKEY_LargeImageLowColor, | VT_UNKNOWN, | 8); ”) // IUIImage |
| cpp_quote(“DEFINE_UIPROPERTYKEY(UI_PKEY_SmallImageHighColor, | VT_UNKNOWN, | 9); ”) // IUIImage |

| | |
|---|---|
| cpp_quote(“DEFINE_UIPROPERTYKEY(UI_PKEY_SmallImageLowColor, VT_UNKNOWN, | 10); ”) // IUIImage |

Table IX illustrates examples of collections properties. The collections properties refer to properties describing a particular collection or group of commands (e.g., a collection of editing controls, a collection of reviewing/markup controls, and so forth). It is to be appreciated that Table IX describes only examples, and that other collections properties can alternatively be used.

TABLE IX

| | | |
|---|---|---|
| cpp_quote(“DEFINE_UIPROPERTYKEY(UI_PKEY_CommandId, | VT_UINT, | 100); ”) |
| cpp_quote(“DEFINE_UIPROPERTYKEY(UI_PKEY_ItemsSource, | VT_UNKNOWN, | 101); ”) |

// IEnumUnknown or IUICollection

| | | |
|---|---|---|
| cpp_quote(“DEFINE_UIPROPERTYKEY(UI_PKEY_Categories, | VT_UNKNOWN, | 102); ”) |

// IEnumUnknown or IUICollection

| | | |
|---|---|---|
| cpp_quote(“DEFINE_UIPROPERTYKEY(UI_PKEY_CategoryId, | VT_UINT, | 103); ”) |
| cpp_quote(“DEFINE_UIPROPERTYKEY(UI_PKEY_SelectedItem, | VT_UINT, | 104); ”) |
| cpp_quote(“DEFINE_UIPROPERTYKEY(UI_PKEY_CommandType, | VT_UINT, | 105); ”) |
| cpp_quote(“DEFINE_UIPROPERTYKEY(UI_PKEY_ItemImage, | VT_UNKNOWN, | 106); ”) |

// IUIImage

Table X illustrates examples of command properties. The command properties refer to properties describing a particular command that is to be presented via the user interface. It is to be appreciated that Table X describes only examples, and that other command properties can alternatively be used.

TABLE X

| | | |
|---|---|---|
| cpp_quote(“DEFINE_UIPROPERTYKEY(UI_PKEY_BooleanValue, | VT_BOOL, | 200); ”) |
| cpp_quote(“DEFINE_UIPROPERTYKEY(UI_PKEY_DecimalValue, | VT_DECIMAL, | 201); ”) |
| cpp_quote(“DEFINE_UIPROPERTYKEY(UI_PKEY_StringValue, | VT_LPWSTR, | 202); ”) |
| cpp_quote(“DEFINE_UIPROPERTYKEY(UI_PKEY_MaxValue, | VT_DECIMAL, | 203); ”) |
| cpp_quote(“DEFINE_UIPROPERTYKEY(UI_PKEY_MinValue, | VT_DECIMAL, | 204); ”) |
| cpp_quote(“DEFINE_UIPROPERTYKEY(UI_PKEY_Increment, | VT_DECIMAL, | 205); ”) |
| cpp_quote(“DEFINE_UIPROPERTYKEY(UI_PKEY_DecimalPlaces, | VT_UINT, | 206); ”) |
| cpp_quote(“DEFINE_UIPROPERTYKEY(UI_PKEY_FormatString, | VT_LPWSTR, | 207); ”) |
| cpp_quote(“DEFINE_UIPROPERTYKEY(UI_PKEY_RepresentativeString, | VT_LPWSTR, | 208); ”) |

Table XI illustrates examples of font command properties. The font command properties refer to properties of fonts to be presented in controls in the user interface. It is to be appreciated that Table XI describes only examples, and that other font command properties can alternatively be used.

TABLE XI

| | | |
|---|---|---|
| cpp_quote(“DEFINE_UIPROPERTYKEY(UI_PKEY_FontProperties, | VT_UNKNOWN, | 300); ”) |

// IPropertyStore

| | | |
|---|---|---|
| cpp_quote(“DEFINE_UIPROPERTYKEY(UI_PKEY_FontProperties_Family, | VT_LPWSTR, | 301); ”) |
| cpp_quote(“DEFINE_UIPROPERTYKEY(UI_PKEY_FontProperties_Size, | VT_DECIMAL, | 302); ”) |
| cpp_quote(“DEFINE_UIPROPERTYKEY(UI_PKEY_FontProperties_Bold, | VT_UINT, | 303); ”) |

// UI_COMMAND_FONTPROPERTIES

| | | |
|---|---|---|
| cpp_quote(“DEFINE_UIPROPERTYKEY(UI_PKEY_FontProperties_Italic, | VT_UINT, | 304); ”) |

// UI_COMMAND_FONTPROPERTIES

| | | |
|---|---|---|
| cpp_quote(“DEFINE_UIPROPERTYKEY(UI_PKEY_FontProperties_Underline, | VT_UINT, | 305); ”) |

// UI_COMMAND_FONTPROPERTIES

| | |
|---|---|
| cpp_quote(“DEFINE_UIPROPERTYKEY(UI_PKEY_FontProperties_Strikethrough, VT_UINT, | 306); ”) |

// UI_COMMAND_FONTPROPERTIES

| | |
|---|---|
| cpp_quote(“DEFINE_UIPROPERTYKEY(UI_PKEY_FontProperties_VerticalPositioning, VT_UINT, | 307); ”) |

// UI_COMMAND_FONTPROPERTIES_VERTICALPOSITIONING

| | | |
|---|---|---|
| cpp_quote(“DEFTNE_UIPROPERTYKEY(UI_PKEY_FontProperties_ForeColor, | VT_UINT, | 308); ”) |

// COLORREF

| | | |
|---|---|---|
| cpp_quote(“DEFINE_UIPROPERTYKEY(UI_PKEY_FontProperties_BackColor, | VT_UINT, | 309); ”) |

// COLORREF

| | | |
|---|---|---|
| cpp_quote(“DEFINE_UIPROPERTYKEY(UI_PKEY_FontProperties_ForeColorType, | VT_UINT, | 310); ”) |

// UI_COMMAND_SWATCHCOLORTYPE

| | | |
|---|---|---|
| cpp_quote(“DEFINE_UIPROPERTYKEY(UI_PKEY_FontProperties_BackColorType, | VT_UINT, | 311); ”) |

// UI_COMMAND_SWATCHCOLORTYPE

| | | |
|---|---|---|
| cpp_quote(“DEFINE_UIPROPERTYKEY(UI_PKEY_ChangedFontProperties, | VT_UNKNOWN, | 312); ”) |

// IPropertyStore

Table XII illustrates examples of application menu properties. The application menu properties refer to properties of a menu that is to be presented as part of the user interface. It is to be appreciated that Table XII describes only examples, and that other application menu properties can alternatively be used.

TABLE XII

| | | |
|---|---|---|
| cpp_quote(“DEFINE_UIPROPERTYKEY(UI_PKEY_RecentItems, | VT_ARRAY\|VT_UNKNOWN, | 350); ”) |
| cpp_quote(“DEFINE_UIPROPERTYKEY(UI_PKEY_Pinned, | VT_BOOL, | 351); ”) |

Table XIII illustrates examples of color picker properties. The color picker properties refer to colors to be used in the user interface. It is to be appreciated that Table XIII describes only examples, and that other color picker properties can alternatively be used.

TABLE XIII

| | | |
|---|---|---|
| cpp_quote(“DEFINE_UIPROPERTYKEY(UI_PKEY_Color, | VT_UINT, | 400); ”) |

// COLORREF

| | | |
|---|---|---|
| cpp_quote(“DEFINE_UIPROPERTYKEY(UI_PKEY_ColorType, | VT_UINT, | 401); ”) |

// UI_COMMAND_SWATCHCOLORTYPE

| | | |
|---|---|---|
| cpp_quote(“DEFINE_UIPROPERTYKEY(UI_PKEY_ColorMode, | VT_UINT, | 402); ”) |

// UI_COMMAND_SWATCHCOLORMODE

| | | |
|---|---|---|
| cpp_quote(“DEFINE_UIPROPERTYKEY(UI_PKEY_LargeIconMask, | VT_UNKNOWN, | 403); ”) |

// IUIImage

| | | |
|---|---|---|
| cpp_quote(“DEFINE_UIPROPERTYKEY(UI_PKEY_SmallIconMask, | VT_UNKNOWN, | 404); ”) |

// IUIImage

| cpp_quote(“DEFINE_UIPROPERTYKEY(UI_PKEY_ThemedColorsCategoryLabel, VT_LPWSTR, | | 405); ”) |
|---|---|---|
| cpp_quote(“DEFINE_UIPROPERTYKEY(UI_PKEY_StandardColorsCategoryLabel, VT_LPWSTR, | | 406); ”) |
| cpp_quote(“DEFINE_UIPROPERTYKEY(UI_PKEY_RecentColorsCategoryLabel, VT_LPWSTR, | | 407); ”) |
| cpp_quote(“DEFINE_UIPROPERTYKEY(UI_PKEY_AutomaticColorLabel, | VT_LPWSTR, | 408); ”) |
| cpp_quote(“DEFINE_UIPROPERTYKEY(UI_PKEY_NoColorLabel, | VT_LPWSTR, | 409); ”) |
| cpp_quote(“DEFINE_UIPROPERTYKEY(UI_PKEY_MoreColorsLabel, | VT_LPWSTR, | 410); ”) |
| cpp_quote(“DEFINE_UIPROPERTYKEY(UI_PKEY_ThemedColors, | VT_VECTOR\|VT_UI4, | 411); ”) |
| cpp_quote(“DEFINE_UIPROPERTYKEY(UI_PKEY_StandardColors, | VT_VECTOR\|VT_UI4, | 412); ”) |
| cpp_quote(“DEFINE_UIPROPERTYKEY(UI_PKEY_ThemedColorsTooltips, | VT_VECTOR\|VT_LPWSTR, | 413); ”) |

| | |
|---|---|
| cpp_quote(“DEFINE_UIPROPERTYKEY(UI_PKEY_StandardColorsTooltips, VT_VECTOR\|VT_LPWSTR, | 414); ”) |

Table XIV illustrates examples of ribbon properties. The ribbon properties refer to properties describing a particular user interface that is a ribbon. It is to be appreciated that Table XIV describes only examples, and that other ribbon properties can alternatively be used.

TABLE XIV

| | | |
|---|---|---|
| cpp_quote(“DEFINE_UIPROPERTYKEY(UI_PKEY_Viewable, | VT_BOOL, | 1000); ”) |
| cpp_quote(“DEFINE_UIPROPERTYKEY(UI_PKEY_Minimized, | VT_BOOL, | 1001); ”) |

| | |
|---|---|
| cpp_quote(“DEFINE_UIPROPERTYKEY(UI_PKEY_QuickAccessToolbarDock, VT_UINT, | 1002); ”) |

Table XV illustrates examples of contextual tabset properties. The contextual tabset properties refer to properties that describe supporting a user's ability to navigate through a user interface using a tab key. It is to be appreciated that Table XV describes only examples, and that other contextual tabset properties can alternatively be used.

TABLE XV

cpp_quote(“DEFINE_UIPROPERTYKEY
(UI_PKEY_ContextAvailable, VT_UINT, 1100); ”)

Table XVI illustrates examples of global properties. The global properties refer to properties describing global properties for the user interface. It is to be appreciated that Table XVI describes only examples, and that other global properties can alternatively be used.

TABLE XVI

| | | |
|---|---|---|
| cpp_quote(“DEFINE_UIPROPERTYKEY(UI_PKEY_GlobalBackgroundColor, | VT_UINT, | 2000); ”) // |
| COLORREF | | |
| cpp_quote(“DEFINE_UIPROPERTYKEY(UI_PKEY_GlobalHighlightColor, | VT_UINT, | 2001); ”) // |
| COLORREF | | |
| cpp_quote(“DEFINE_UIPROPERTYKEY(UI_PKEY_GlobalTextColor, | VT_UINT, | 2002); ”) // |
| COLORREF | | |

A variety of interfaces are also included as part of this example API 104 and/or application 102, as discussed above. One of these interfaces is the IUIFRAMEWORK interface (e.g., interface 410 of FIG. 4). The IUIFRAMEWORK interface is implemented by API 104 and represents user interface platform 108. Application 102 typically uses the IUIFRAMEWORK interface to initialize and tear down the framework, make framework-wide changes, as well as to send in the description of the commands that are to be made available to the user. To get an interface pointer to IUIFRAMEWORK, application 102 uses CoCreateInstance( ) to create a COM object with the CLSID identifying the framework (e.g., a CLSID of “Scenic Intent Framework Interface”).

The IUIFRAMEWORK interface exposes the following methods: Initialize, Destroy, LoadUI, GetView, GetUICommandProperty, SetUICommandProperty, InvalidateUICommand, and SetModes. These methods are discussed in more detail below.

The Initialize method is invoked by application 102 to connect the framework with application 102. The Initialize method is called for each top level application window opened or used by application 102. An example implementation of the Initialize method is as follows:
HRESULT Initialize(HWND frameWnd, [in] IUIApplication* application);
[in] Parameters
   frameWnd
      A handle to the window in which the user interface is to be displayed.
   application
      An interface pointer to IUIApplication implemented by application 102. This allows API 104 to invoke callbacks to the application 102.
[out] Parameters
   None
Return values
   S_OK
      The operation completed successfully.
   E_FAIL
      The operation failed. The framework is not set up.

The Destroy method is invoked by application 102 to release all framework objects. The Destroy method is called for an instance of API 104 to ensure proper tear down of the framework (e.g., when the user interface is no longer to be displayed). An example implementation of the Destroy method is as follows:
HRESULT Destroy( );
[in] Parameters
   None
[out] Parameters
   None
Return values
   S_OK
      The operation completed successfully.
   E_FAIL
      The operation failed.

The LoadUI method is exposed by API 104 and invoked by application 102 to load the one or more views specified in the markup or other description of the user interface. The LoadUI method is invoked one upon initialization of the user interface. An example implementation of the Load UI method is as follows:
HRESULT LoadUI(HINSTANCE instance, [in] LPCWSTR resourceName);
[in] Parameters
   instance
      A handle to a module of application 102 that contains the binary user interface description (e.g., markup) resource.
   resourceName
      The name of the application resource to load, which contains the binary user interface description (e.g., markup).
[out] Parameters
   None
Return values
   S_OK
      The operation completed successfully.
   E_FAIL
      The operation failed. The resource is not loaded and the user interface will not be displayed.

The GetView method is invoked by application 102 to obtain pointers to the other framework-implemented interfaces, such as IUIRibbon. The GetView method can also be used to obtain pointers to other interfaces. An example implementation of the GetView method is as follows:

HRESULT GetView(UINT32 viewId, REFIID riid, [out, iid_is(riid),
annotation(“_deref_out”)] void** ppv);

[in] Parameters
   viewId
      The command ID to the view requested. For IUIRibbon this is zero.
   riid
      The interface ID of the requested interface.
[out] Parameters
   ppv
      Upon success, contains the requested interface pointer.
Return values
   S_OK
      The operation completed successfully.
   E_INVALIDARG
      The operation failed due to invalid arguments. The value of *ppv is unspecified.

The GetUICommandProperty method is invoked by application 102 to retrieve the current value of one or more properties. It should be noted that not all properties available in the framework need be retrievable by the GetUICommandProperty method. An example implementation of the GetUICommandProperty method is as follows:

HRESULT GetUICommandProperty(UINT32 commandId, [in]
REFPROPERTYKEY key, [out] PROPVARIANT* value);

[in] Parameters
   commandId
      The command ID to the user interface command from which to retrieve property values.
   key
      The key of the property the value of which is retrieved. Table XVII shows an example of which property keys are supported for which types of user interface commands.
[out] Parameters
   value
      Upon success, contains the current value of the property.
Return values
   S_OK
      The operation completed successfully.
   HRESULT_FROM_WIN32(ERROR_NOT_SUPPORTED)
      The operation failed because the property key is not supported by the specified command.

TABLE XVII

| | | Other command | | | Enter | Item |
|---|---|---|---|---|---|---|
| | QAT | not explicitly listed | Galleries | Boolean | Decimal | Galleries |
| PKEY_Enabled | | X | X | X | X | X |
| PKEY_ItemsSource | X | | X | | | X |
| PKEY_Categories | | | X | | | X |
| PKEY_SelectedItem | | | | | | X |
| PKEY_BooleanValue | | | | X | | |
| PKEY_DecimalValue | | | | | X | |

The SetUICommandProperty method is invoked by application 102 to set the current value of one or more properties. API 104, in response to a property being set, need not update the property right away, but rather can update the property and have the change reflected in the user interface when it decides to do so. It should be noted that not all properties in the framework need be settable by the SetUICommandProperty method. An example implementation of the SetUICommandProperty method is as follows:

HRESULT SetUICommandProperty(UINT32 commandId, [in]
REFPROPERTYKEY key, [in] REFPROPVARIANT value);

[in] Parameters
   commandId
      The command ID to the user interface command from which to set property values.
   key
      The key of the property the value of which is set. Table XVII above shows an example of which property keys are supported for which types of user interface commands.
   value
      Contains the current value of the property that the application wants to be set.
Return values
   S_OK
      The operation completed successfully.
   HRESULT_FROM_WIN32(ERROR_NOT_SUPPORTED)
      The operation failed because the property key is not supported by the specified command.

The InvalidateUICommand method is invoked by application 102 to invalidate one or more specified command. API 104, in response to the InvalidateUICommand method being invoked, calls application 102 for the updated values for one or more specified properties of the one or more specified commands. An example implementation of the InvalidateUICommand method is as follows:

HRESULT InvalidateUICommand(UINT32 commandId,
UI_COMMAND_INVALIDATIONFLAGS flags, [in,
annotation(“_in_opt”)] const PROPERTYKEY* key);

[in] Parameters
   commandId
      ID for the invalidated command, which will have its property (or properties) queried. Passing a value of UICOMMAND_ALL_COMMANDS will cause all loaded commands to be invalidated.
   flags
      Flags that specify how the properties will be invalidated. A configuration of flags that may cause a property to be invalidated more than once (such as combining UIC_INVALIDATE_STATE and UIC_INVALIDATE_ALL_PROPERTIES) will only cause one call back for each property requested. In other words, duplicate effects of the flags are combined.
   key
      The key to the property being queried, when the UIC_INVALIDATE_PROPERTY flag is set. It has no effect otherwise.
[out] Parameters
   None
Return values
   S_OK
      The operation completed successfully.
   S_FALSE
      The operation succeeded, but some of all of the commands have failed to invalidate, or some properties are not supported by all of the commands. The framework state has been changed.
   E_FAIL
      The operation failed. None of the commands supports the property or properties requested, or an internal error occurred.

The SetModes method is invoked by application 102 to set which application modes are to be active in the user interface. The API supports changing the user interface based on the application context, where the application can express the context by Modes and Contextual Tabs. Modal controls in the user interface that are bound to that mode will be shown visually. If a control is associated with a mode, but the mode is not set to “Active”, then that control will not appear in the user interface nor will other controls that rely on that control. For example, if a Tab is in Mode 1 and a Group within that tab is in Mode 2, then setting 2 as the only active mode will not show either the Tab or the Group, since the Group needs to have both its own mode and the mode of its parent to be “active” in order to be displayed. In other words, Modes 1 and 2 would be set in the SetModes call. This also implies that modes are additive. An example implementation of the SetModes method is as follows:
HRESULT SetModes(INT32 iModes);
[in] Parameters
   iModes
      A 32-bit value representing (bitwise) which modes are to be set. The least significant bit represents mode 0. In other words, if mode 5 is to be set, the 6^{th} bit in the integer is to be set to 1, making iModes =0x00000020h=32.
      To pack multiple modes into this value, a helper function UI_MAKEAPPMODE(x) can be used, where x is the desired mode, or 1<<x directly, and logically OR all these values to form the parameter.
[out] Parameters
   None
Return values
   S_OK
      The operation completed successfully.
   E_FAIL
      The operation failed. No change to the active modes was made.

The IUIAPPLICATION interface (e.g., interface 406 of FIG. 4) is implemented by application 102. The IUIAPPLICATION interface represents application 102 and provides callback methods for user interface platform 108 to use when platform 108 desires information from application 102. The IUIAPPLICATION interface exposes the following methods: OnViewChanged, OnCreateUICommand, and OnDestroyUICommand. These methods are discussed in more detail below.

The OnViewChanged method is invoked by user interface platform 108 when a view requests positioning from application 102. For example, OnViewChanged could be called when a user interface (e.g., a ribbon) is created from markup during initialization, when the user collapses the ribbon, when the user expands the ribbon, and so forth. An example implementation of the OnViewChanged method is as follows:

HRESULT OnViewChanged(UINT32 viewId, [in]
UI_COMMAND_TYPE typeID, [in] IUnknown* view,
UI_VIEW_VERB verb, INT32 uReasonCode);

[in] Parameters
   viewId
      The ID for the View to be laid out, specified as an attribute of the description of the user interface (e.g., the markup). The ID is zero for the ribbon itself.
   typeID
      The type of the control for which a re-layout is to be performed. It type is UICTI_RIBBON for the ribbon.
   view p2 The interface pointer to the view for which the layout is to be performed.
   verb
      The nature of the view change.
   uReasonCode
      Reserved Parameter.
[out] Parameters
   None
Return values
   S_OK
      The operation completed successfully.
   E_FAIL
      The operation failed. The ribbon will remain at its current height.

The OnCreateUICommand method is invoked by user interface platform 108 each time platform 108 creates a new command. For example, OnCreateUICommand is called when a command is created from the user interface description (e.g., markup) during initialization. Application 102 responds to the OnCreateUICommand method with a command handler for the command (which implements the IUICommandHandler interface discussed in more detail below). An example implementation of the OnCreateUICommand method is as follows:

```
HRESULT OnCreateUICommand(UINT32 commandId,
              [in] UI_COMMAND_TYPE typeID,
              [out] IUICommandHandler** commandHandler);
```

[in] Parameters
   commandId
      The command ID of the command that was created, specified as an attribute of the description of the user interface (e.g., the markup.
   typeID
      The type of this command
[out] Parameters
   commandHandler
      An application-provided command handler for the Command.
Return values
   S_OK
      The operation completed successfully.
   E_FAIL
      The operation failed. The commandHandler parameter is to be ignored.

The OnDestroyUICommand method is invoked by user interface platform 108 each time platform 108 destroys a command. For example, OnDestroyUICommand is called when the user interface (e.g., a ribbon) is torn down as a consequence of a call to the Destroy method of IUIFramework. An example implementation of the OnDestroyUICommand method is as follows:

HRESULT OnDestroyUICommand(UINT32 commandId,
[in] UI_COMMAND_TYPE typeID);

[in] Parameters
   commandId
      The command ID of the command that was destroyed
   typeID
      The type of this command
Return values
   S_OK
      The operation completed successfully.
   E_FAIL
      The operation failed.

The IUICOMMANDHANDLER interface (e.g., interface 408 of FIG. 4) is implemented by application 102. The IUICOMMANDHANDLER interface represents the implementation of a command by application 102. During initialization, each command is bound to a command handler through the OnCreateUICommand method, so the command is also bound to the command that the handler represents. This can be a many to one relationship—many commands (and corresponding controls) can be bound to the same command handler. The command handler is responsible for updating values of the properties of the command to which it is bound, such as setting it to be enabled or disabled. The command handler is also responsible for executing actions invoked on the command to which it is bound.

The IUICOMMANDHANDLER interface exposes the following methods: Execute and UpdateProperty. These methods are discussed in more detail below.

The Execute method is invoked by user interface platform 108 when a user takes input action against one of the commands associated with the command handler. For example, the Execute method would be called when a user clicks on a control corresponding to a command bound to this command handler. An example implementation of the Execute method is as follows:

```
HRESULT Execute(UINT32 commandId,
    UI_COMMAND_EXECUTIONVERB verb,
    [in, annotation(“_in_opt”)] const PROPERTYKEY* key,
    [in, annotation(“_in_opt”)] const PROPVARIANT* currentValue,
    [in, annotation(“_in_opt”)] IUISimplePropertySet*
commandExecutionProperties);
```

[in] Parameters
   commandId
      ID of the command to be executed.
   verb
      The type of action that occurred, such as “Execute”, “Preview”, and so forth.
   key
      The optional key to the property that the action has changed.
   currentValue
      The optional new current value of the command due to the action performed. The type of this variant varies for each command.
   commandExecutionParameters
      Pointer to indicate optional execution parameters.
[out] Parameters
   None
Return values
   S_OK
      The operation completed successfully.
   E_FAIL
      The operation failed. Indicates to the framework that it is to try to recover.

The UpdateProperty method is invoked by user interface platform 108 to request that application 102 update the value of the specified property in the specified command it represents. An example implementation of the UpdateProperty method is as follows:

```
HRESULT UpdateProperty(UINT32 commandId,
    [in] REFPROPERTYKEY key,
    [in, annotation(“_in_opt”)] const PROPVARIANT* currentValue,
    [out] PROPVARIANT* newValue);
```

[in] Parameters
   commandID
      The command ID whose status is to be updated by the application.
   key
      The key of the property for which the framework is requesting a new value.
   currentValue
      The current value of the property.
[in/out] Parameters
   newValue
      The new value of the property. The application passes its calculated value in this parameter.
[out] Parameters
   None
Return values
   S_OK
      The operation completed successfully.
   E_FAIL
      Used to indicate to the framework that the command implementation does not support this property, or the application has failed to compute a new value for the property. The newValue parameter is to be ignored.

The IUISIMPLEPROPERTYSET interface (e.g., interface 412 of FIG. 4) is implemented by API 104 and represents user interface platform 108. The IUISIMPLEPROPERTYSET interface provides read access to various properties that can be set on commands exposed via controls of platform 108. In one or more embodiments, Galleries and QAT commands support the IUISIMPLEPROPERTYSET interface. The IUISIMPLEPROPERTYSET interface exposes the GetValue method, which is discussed in more detail below.

The GetValue method is invoked by application 102 to request the stored value of a given property. An example implementation of the GetValue method is as follows:

HRESULT GetValue([in] REFPROPERTYKEY key, [out]
PROPVARIANT* value);

[in] Parameters
   key
      The property to be retrieved.
[out] Parameters
   value
      The stored value associated with the specified property.
Return values
   S_OK
      The operation completed successfully.
   E_FAIL
      The operation failed. The value of the value parameter is unspecified.

The IUIRIBBON interface (e.g., interface 414 of FIG. 4) is implemented by API 104 and represents user interface platform 108. The IUIRIBBON interface provides a ribbon view (a user interface that is a ribbon) and allows various interaction regarding the size of the ribbon. This ribbon view has multiple components, such as Application Menu Button, Quick Access Toolbar, tabs, groups (also referred to as groups), and so forth. The IUIRIBBON interface exposes the following methods: GetDesiredHeight, SetHeight, SaveSettingsToStream, and LoadSettingsFromStream. These methods are discussed in more detail below.

The GetDesiredHeight method is invoked by application 102 to obtain the height (e.g., thickness) that the user interface platform 108 desires to make the ribbon, based on an indicator of how much room application 102 desires to sacrifice at the top of the frame for the ribbon. Application 102 calls the GetDesiredHeight method to suggest the largest height it desires the ribbon to have, which is stored as a value cyMax. Platform 108 responds to the application by stating the size platform 108 desires to use for the ribbon. The GetDesiredHeight method is the first part of a two-phase negotiation between platform 108 and application 102, aimed at determining how much room the ribbon is to take up on the screen. The GetDesiredHeight method is to be called before the SetHeight method, which is the second phase of the negotiation and is discussed in more detail below. An example implementation of the GetDesiredHeight method is as follows:
HRESULT GetDesiredHeight(UINT32 cyMax, [out] UINT32* cy);
[in] Parameters
   cyMax
      The maximum number of vertical pixels that the application is willing to provide for the ribbon.
[out] Parameters
   cy
      A response by the framework, meant to indicate the amount of room (pixels) that the framework wants to use for the ribbon.
Return values
   S_OK
      The operation completed successfully.
   E_FAIL
      The operation failed.

The SetHeight method is invoked by application 102 to set the height (e.g., thickness) for the ribbon. This height can be the height output by the GetDesiredHeight method, or alternatively height determined by application 102. The SetHeight method is the second part of the two-phase negotiation that takes place between application 102 and platform 108. The SetHeight method is normally called after the GetDesiredHeight method is called. In one or more embodiments, the call to the GetDesiredHeight method is a courtesy call as application 102 can choose to ignore the desired height returned by the GetDesiredHeight method. An example implementation of the SetHeight method is as follows:
HRESULT SetHeight(UINT32 cy);
[in] Parameters
   cy
      The vertical height that the ribbon is to occupy. If this height is insufficient to display the ribbon, platform 108 will attempt to reduce or eliminate the visible profile of the Ribbon. This value can be the output cy value from the GetDesiredHeight method.
[out] Parameters
   None
Return values
   S_OK
      The operation completed successfully.
   E_FAIL
      The operation failed. The height of the ribbon is unchanged.

The SaveSettingsToStream method is invoked by application 102 to save the state of the user interface to a binary stream that can be loaded later using the LoadSettingsFromStream method. An example implementation of the SaveSettingsToStream method is as follows:
HRESULT SaveSettingsToStream([in] IStream *pStream);
[in] Parameters
   pstream
      The stream to save to.
[out] Parameters
   None
Return values
   S_OK
      The stream was saved successfully.
   E_FAIL
      The operation failed.

The LoadSettingsFromStream method is invoked by application 102 to load the state of the QAT from a stream. An example implementation of the LoadSettingsFromStream method is as follows:
HRESULT LoadSettingsFromStream([in] IStream *pStream);
[in] Parameters
   pstream
      The stream to load from.
[out] Parameters
   None
Return values
   S_OK
      The stream was saved successfully.
   E_FAIL
      The operation failed.

The IUIIMAGEFROMBITMAP interface (e.g., interface 416 of FIG. 4) is implemented by API 104 and represents user interface platform 108. Icons in the user interface (e.g., a ribbon) are represented as objects of type IUIImage. The IUIIMAGEFROMBITMAP interface provides IUIIMages from images of type HBITMAP. The IUIIMAGEFROMBITMAP interface exposes the following methods: CreateImageFromBitmap and GetImageFromBitmap. These methods are discussed in more detail below.

The CreateImageFromBitmap method is invoked by application 102 to create an IUIImage object from an image of type HBITMAP. When using the CreateImageFromBitmap method, application 102 is responsible for destroying the object of the bitmap image. An example implementation of the CreateImageFromBitmap method is as follows:

HRESULT CreateImageFromBitmap([in] HBITMAP bitmap, [out]
IUIImage **image);

[in] Parameters
   bitmap
      An HBITMAP for the IUIImage.
[out] Parameters
   image
      The resultant IUImage.
Return values
   S_OK
      The operation completed successfully.
   E_FAIL
      The operation failed. The resultant IUImage is not to be used.

The GetImageFromBitmap method is invoked by application 102 to create an IUIImage object from an image of type HBITMAP. When using the GetImageFromBitmap method, the IUIImage object is responsible for destroying the object of the bitmap image. An example implementation of the GetImageFromBitmap method is as follows:

HRESULT GetImageFromBitmap([in] HBITMAP bitmap, [out]
IUIImage **image);

[in] Parameters
   bitmap
      An HBITMAP for the IUIImage.
[out] Parameters
   image
      The resultant IUImage.
Return values
   S_OK
      The operation completed successfully.
   E_FAIL
      The operation failed. The resultant IUImage is not to be used.

The IUIIMAGE interface (e.g., interface 418 of FIG. 4) is implemented by API 104 and represents user interface platform 108. Icons in the user interface (e.g., a ribbon) are represented as objects of type IUIImage. The IUIIMAGE interface allows images of type HBITMAP to be obtained. The IUIIMAGE interface exposes the following GetBitmap method, which is discussed in more detail below.

The GetBitmap method is invoked by application 102 to retrieve an image of type HBITMAP from an IUIImage object. An example implementation of the GetBitmap method is as follows:
HRESULT GetBitmap([out] HBITMAP *bitmap);
[in] Parameters
   None
[out] Parameters
   bitmap
      The HBITMAP.
Return values
   S_OK
      The operation completed successfully.
   E_FAIL
      The operation failed. The resultant HBITMAP is not to be used.

The IUICOLLECTION interface (e.g., interface 420 of FIG. 4) is implemented by API 104 and represents user interface platform 108. Some controls can present multiple items at the same time in the user interface, and those items are grouped together as a collection. An item can take different forms, including being textual, iconic, and so forth, and can be presented in a variety of different manners, such as in a list, in a grid, and so forth. A user is able to choose one or several items from the collection presented to them inside the control. The IUICOLLECTION interface allows the application to communicate the collection of items inside a control to the framework, for display and user interaction. The IUICOLLECTION interface 420 exposes the following methods for collections of items: GetCount, GetItem, Add, Insert, RemoveAt, Replace, and Clear. These methods are discussed in more detail below.

The GetCount method is invoked to retrieve a count of items in the collection. An example implementation of the GetCount method is as follows:
HRESULT GetCount([out] UINT32* count);
[in] Parameters
   None
[out] Parameters
   count
      The count of items in the collection.
Return values
   S_OK
      The operation completed successfully.
   E_FAIL
      The operation failed.

The GetItem method is invoked to retrieve a particular item from the collection. An example implementation of the GetItem method is as follows:

HRESULT GetItem(UINT32 index, [out, annotation(“_deref_out”)]
IUnknown** item);

[in] Parameters
   index
      The position of the item to be retrieved.
[out] Parameters
   item
      The item stored at the input position.
Return values
   S_OK
      The operation completed successfully.
   E_FAIL
      The operation failed.

The Add method is invoked to add an item to the end of the collection. An example implementation of the Add method is as follows:
HRESULT Add([in] IUnknown* item);
[in] Parameters
   item
      The item to be added to the collection.
[out] Parameters
   None
Return values
   S_OK
      The operation completed successfully.
   E_FAIL
      The operation failed.

The Insert method is invoked to insert an item at a particular position in the collection. An example implementation of the Insert method is as follows:
HRESULT Insert(UINT32 index, [in] IUnknown* item);
[in] Parameters
   index
      The position in the collection where the item is to be inserted.
[out] Parameters
   item
      The item to be inserted into the collection.
Return values
   S_OK
      The operation completed successfully.
   E_FAIL
      The operation failed.

The RemoveAt method is invoked to remove an item at a specified position from the collection. An example implementation of the RemoveAt method is as follows:
HRESULT RemoveAt(UINT32* index);
[in] Parameters
   index
      The position in the collection at which the item to be removed is located.
[out] Parameters
   None.
Return values
   S_OK
      The operation completed successfully.
   E_FAIL
      The operation failed.

The Replace method is invoked to replace an item at a specified position with another item. An example implementation of the Replace method is as follows:

HRESULT Replace(UINT32 indexReplaced, [in] IUnknown*
itemReplaceWith);

[in] Parameters
   indexReplaced
      The position in the collection of the item to be replaced.
   itemReplace With
      The item to be added to the collection in replacing the previous item at the specified position.
[out] Parameters
   None.
Return values
   S_OK
      The operation completed successfully.
   E_FAIL
      The operation failed.

The Clear method is invoked to clear the collection, removing all items from the collection. An example implementation of the Clear method is as follows:
HRESULT Clear( );
[in] Parameters
   None
[out] Parameters
   None
Return values
   S_OK
      The operation completed successfully.
   E_FAIL
      The operation failed.

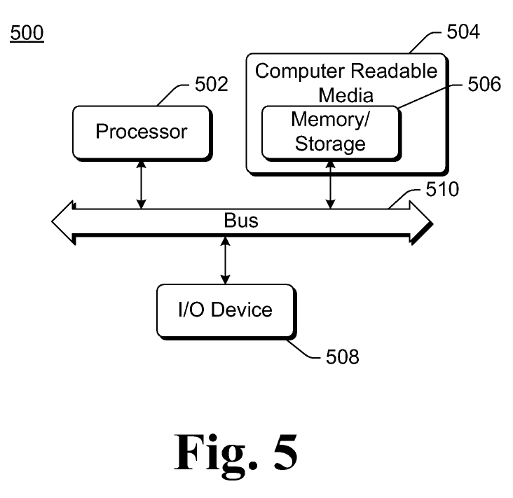

FIG. 5 illustrates an example computing device 500 that can be configured to implement the intent-oriented user interface Application Programming Interface in accordance with one or more embodiments. Computing device 500 can be, for example, computing device 100 of FIG. 1.

Computing device 500 includes one or more processors or processing units 502, one or more computer readable media 504 which can include one or more memory and/or storage components 506, one or more input/output (IO) devices 508, and a bus 510 that allows the various components and devices to communicate with one another. Computer readable media 504 and/or one or more I/O devices 508 can be included as part of, or alternatively may be coupled to, computing device 500. Bus 510 represents one or more of several types of bus structures, including a memory bus or memory controller, a peripheral bus, an accelerated graphics port, a processor or local bus, and so forth using a variety of different bus architectures. Bus 510 can include wired and/or wireless buses.

Memory/storage component 506 represents one or more computer storage media. Component 506 can include volatile media (such as random access memory (RAM)) and/or nonvolatile media (such as read only memory (ROM), Flash memory, optical disks, magnetic disks, and so forth). Component 506 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 502. It is to be appreciated that different instructions can be stored in different components of computing device 500, such as in a processing unit 502, in various cache memories of a processing unit 502, in other cache memories of device 500 (not shown), on other computer readable media, and so forth. Additionally, it is to be appreciated that the location where instructions are stored in computing device 500 can change over time.

One or more input/output devices 508 allow a user to enter commands and information to computing device 500, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The term “module” as used herein generally represents software, firmware, hardware, or combinations thereof. In the case of a software implementation, the module represents program code that performs specified tasks when executed on a processor (e.g., CPU or CPUs). The program code can be stored in one or more computer readable media, further description of which may be found with reference to FIG. 5. The features of the intent-oriented user interface Application Programming Interface techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
presenting a user interface for an application, the user interface having been generated by a user interface platform based in part on an indication of commands to be exposed received from the application, but a presentation of controls of the user interface and an interaction model for the user interface being determined by the user interface platform; and
in response to a user interaction with the user interface, notifying the application of the user interaction.

2. A method as recited in claim 1, further comprising exposing an interface to allow the user interface platform to be initialized by the application, and to allow the application to send the indication of commands to the user interface platform.

3. A method as recited in claim 2, the interface being an IUIFRAMEWORK interface.

4. A method as recited in claim 2, the interface including a load user interface method to be invoked by the application to load one or more views for the user interface.

5. A method as recited in claim 1, further comprising exposing an interface to allow communication between the user interface platform and the application regarding a size of a ribbon user interface.

6. A method as recited in claim 1, further comprising exposing an interface to provide read access to one or more properties that can be set on commands exposed via controls of the user interface platform.

7. A method as recited in claim 1, the notifying comprising invoking a particular interface of the application, the particular interface being an interface representing an implementation of a command by the application.

8. A method as recited in claim 7, the particular interface including an execute method to be invoked by the user interface application when a user input is detected.

9. A method as recited in claim 1, the indication of the commands having been received from a particular interface of the application, the particular interface being an interface to provide callback methods for the user interface platform.

10. A method as recited in claim 9, the particular interface including a method to be invoked by the user interface platform to obtain a command handler for a command corresponding to a control to be displayed in a user interface by the user interface platform.

11. One or more computer storage media having stored thereon multiple instructions that, when executed by one or more processors of a computing device, cause the one or more processors to:
receive, via an Application Programming Interface (API), an indication from an application of multiple commands to be exposed for the application via a user interface;
determine on behalf of the application, for each of the multiple commands, a manner of display of a control corresponding to the command and a user interaction model for the control; and
display, for each of the multiple commands, the control corresponding to the command in accordance with the determined manner of display for the control.

12. One or more computer storage media as recited in claim 11, the API exposing an interface to allow a user interface platform to be initialized by the application, and to allow the application to send the indication of the multiple commands to the user interface platform.

13. One or more computer storage media as recited in claim 11, the API exposing an interface to allow communication between a user interface platform implementing the API and the application regarding a size of a ribbon user interface.

14. One or more computer storage media as recited in claim 11, the instructions further causing the one or more processors to invoke a particular interface of the application to notify the application of a user interaction with the user interface, the particular interface being an interface representing an implementation of a command by the application.

15. One or more computer storage media as recited in claim 11, the indication of the multiple commands having been received from a particular interface of the application, the particular interface being an interface to provide callback methods for the API.

16. A method comprising:
sending to a user interface platform, via an Application Programming Interface (API), an indication of multiple commands to be exposed via a user interface, a manner of interaction and position of controls in the user interface corresponding to the multiple commands being determined by the user interface platform; and
receiving, via the API, a notification of a user's intent with a user input to the user interface.

17. A method as recited in claim 16, further comprising invoking methods of an interface exposed by the API to allow the user interface platform to be initialized by the application, and to allow the application to send the indication of commands to the user interface platform.

18. A method as recited in claim 16, further comprising exposing multiple interfaces, each of the multiple interfaces representing an implementation of one of the multiple commands by the application, and the receiving comprising the API having invoked one of the multiple interfaces.

19. A method as recited in claim 16, further comprising exposing an interface to provide callback methods for the user interface platform.

20. A method as recited in claim 16, further comprising invoking methods of an interface exposed by the API to allow communication between the user interface platform and the application regarding a size of a ribbon user interface.
